(19) United States
(12) Patent Application Publication
(10) Pub. No.: US 2017/0247580 A1
(43) Pub. Date: Aug. 31, 2017

(54) FOIL WRAP WITH CLING PROPERTIES

(71) Applicants: Rohm and Haas Company, Philadelphia, PA (US); Dow Global Technologies LLC, Midland, MI (US)

(72) Inventors: Swapnil Chandak, Pearland, TX (US); Rajen M. Patel, Lake Jackson, TX (US); William B. Griffith, JR., North Wales, PA (US); Daniel W. Himmelberger, Green Lane, PA (US)

(73) Assignees: Rohm and Haas Company, Philadelphia, PA (US); Dow Global Technologies LLC, Midland, MI (US)

(21) Appl. No.: 15/509,211

(22) PCT Filed: Sep. 17, 2015
(86) PCT No.: PCT/US2015/050654

§ 371 Date: Mar. 7, 2017

Related U.S. Application Data
(60) Provisional application No. 62/053,382, filed on Sep. 22, 2014.

(51) Int. Cl. C09J 7/02

(52) U.S. Cl. CPC C09J 7/0292; C09J 7/0246; C09J 7/025; C09J 153/00

(57) ABSTRACT

A cling foil comprising an outermost adhesive layer comprising a pressure sensitive adhesive, an outermost release layer, the outermost release layer comprising a release material, and a foil layer positioned between the outermost adhesive layer and the outermost release layer.

### TECHNICAL FIELD

Embodiments of the present disclosure generally relate to foils, and, in particular, to foils having cling properties, and methods of making thereof.

### BACKGROUND

Aluminum foils are widely used in the consumer market and have many applications, for example, as a protective wrap to contain or package food, pharmaceuticals, or other items. As a protective wrap, aluminum foils may be used to cover one or more surfaces of a container in which the food, pharmaceuticals, or other items are housed or by wrapping the aluminum foil around itself to contain the contents. Aluminum foils may further be used to protect contents during cooking, grilling, and/or freezing. The protective wrap may reduce the degree of exposure of the contents to the environment (e.g., light, oxygen). However, aluminum foils, particularly, those in roll form, are not usually adhesive and therefore, may not adhere well to itself or to container surfaces in order to create a sealed environment.

Accordingly, alternative aluminum foils may be desired having good adhesive properties to a variety of surfaces (for example, plastic, paper, metal, wood, or even STYROFOAM® in order to create a seal, while also being not too tacky so that the aluminum foil is still easy to unwind.

### SUMMARY

Disclosed in embodiments herein are cling foils. The cling foils comprise an outermost adhesive layer comprising a pressure sensitive adhesive, an outermost release layer, the outermost release layer comprising a release material, and a foil layer positioned between the outermost adhesive layer and the outermost release layer.

Also disclosed in embodiments herein are methods of manufacturing a cling foil. The methods comprise providing a foil layer having a first side and a second side, forming an outermost adhesive layer, directly or indirectly, onto the first side of the foil layer, and forming an outermost release layer, directly or indirectly, onto the second side of the foil layer, wherein the outermost adhesive layer, foil layer, and outermost release layer together form a cling foil.

Additional features and advantages of the embodiments will be set forth in the detailed description which follows, and in part will be readily apparent to those skilled in the art from that description or recognized by practicing the embodiments described herein, including the detailed description which follows, the claims, as well as the appended drawings.

It is to be understood that both the foregoing and the following description describe various embodiments and are intended to provide an overview or framework for understanding the nature and character of the claimed subject matter.

### DETAILED DESCRIPTION

Reference will now be made in detail to embodiments of cling foils, and method of manufacturing cling foils. The cling foils comprise an outermost adhesive layer comprising a pressure sensitive adhesive, an outermost release layer comprising a release material, and a foil layer positioned between the outermost adhesive layer and the outermost release layer. As used herein, “pressure sensitive adhesive” refers to a material having a Tg below −20° C. and a shear elastic modulus (G′) at 25° C. between 10⁵-10⁷ dynes/cm determined at 5% strain, 6.3 rad/sec. Tg, which is the glass transition temperature, may be determined using Differential Scanning Calorimetry (DSC) in accordance with ASTM E-1356 using the midpoint as the glass transition temperature and a heating rate of 10° C./min. Shear elastic modulus (G′) may be determined using Dynamic Mechanical Analysis (DMA) as described below. The method of manufacturing a cling foil comprises providing a foil layer having a first side and a second side, forming an outermost adhesive layer, directly or indirectly, onto the first side of the foil layer, and forming an outermost release layer, directly or indirectly, onto the second side of the foil layer, wherein the outermost adhesive layer, foil layer, and outermost release layer together form a cling foil.

In embodiments herein, the thickness ratio of the foil layer to the outermost adhesive and release layers ranges from 1:5 to 10:1. All individual values and subranges of from 1:5 to 10:1 are included and disclosed herein. For example, in some embodiments, the thickness ratio of the foil layer to the outermost adhesive and release layers may range from 1:3 to 8:1.

In other embodiments, the thickness ratio of the foil layer to the outermost adhesive and release layers may range from 1:2 to 7:1. In embodiments herein, the thickness ratio of the foil layer to the outermost adhesive and release layers may also range from 3:1 to 1:3. All individual values and subranges of from 3:1 to 1:3 are included and disclosed herein.

Foil Layer

The foil layer may have a thickness of from 0.2-2.0 mils. All individual values and subranges of from 0.2-2.0 mils are included and disclosed herein. For example, in some embodiments, the foil layer may have a thickness of from 0.2-1.5 mils. In other embodiments, the foil layer may have a thickness of from 0.2-1.0 mils. In further embodiments, the foil layer may have a thickness of from 0.2-0.5 mils.

The foil layer may be an aluminum foil layer or an aluminum-alloy foil layer. Aluminum and aluminum-alloy compositions used to make aluminum-based foils, as well as method for production of aluminum-based foils, are well known in the art and are described in, for example, U.S. Pat. Nos. 5,466,312 or 5,725,695, which are incorporated herein by reference. It should be understood, however, that other metals or metal alloys can be used to form the foil layer, including, for example, copper, silver, chromium, tin, iron, or alloys thereof. Suitable foils are commercially available from Reynolds Consumer Products LLC (Lake Forest, Ill.).

In embodiments herein, the foil may be a wettable foil. As used herein, “wettable” or “wettability” refers to the contact and spread of a liquid over the surface of the foil such that intimate contact is achieved and the liquid provides a continuous film on the surface of the foil. It will be clear to the skilled person that the foil should have a sufficient wettability to promote an even or uniform distribution of a liquid over the foil. Wettability may be determined according to the water break test, ASTM F22.

Outermost Adhesive Layer

In embodiments herein, the outermost adhesive layer may have a thickness of from 0.05-6.0 mils. All individual values and subranges of from 0.05-6.0 mils are included and disclosed herein. For example, in some embodiments, the outermost adhesive layer may have a thickness of from 0.05-3.0 mils. In other embodiments, the outermost adhesive layer may have a thickness of from 0.05-2.0 mils. In further embodiments, the outermost adhesive layer may have a thickness of from 0.05-0.25 mils. In even further embodiments, the outermost adhesive layer may have a thickness of from 0.5-1.5 mils. It should be understood, however, that the thickness of the adhesive layer may vary depending upon the level of desired adhesiveness. Factors that may affect the thickness of the outermost adhesive layer may include the presence of a filler or other additive that can affect adhesiveness, the level of polymer cross-linking, the evenness and/or pattern of the outermost adhesive layer, etc.

The outermost adhesive layer comprises a pressure sensitive adhesive. The pressure sensitive adhesive comprises a material having a Tg below −20° C. and an shear elastic modulus (G′) at 25° C. between 10⁵-10⁷ dynes/cm determined at 5% strain, 6.3 rad/sec. As previously mentioned, Tg may be determined by DSC, and the shear elastic modulus (G′) may be determined by DMA. In some embodiments, the pressure sensitive adhesive is an acrylic polymer. As used herein, “acrylic polymer” refers to polymers having greater than 50% of the polymerized units derived from acrylic monomers. Acrylic resins and emulsions containing acrylic resins are generally known in the art, and reference may be had to The Kirk-Othmer, Encyclopedia of Chemical Technology, Volume 1, John Wiley & Sons, Pages 314-343, (1991), ISBN 0-471-52669-X (v. 1).

Examples of suitable monomers that can be used to form acrylic resins may include alkyl methacrylates having 1-12 carbon atoms, such as, methyl methacrylate, ethyl methacrylate, butyl methacrylate, hexyl methacrylate, 2-ethylhexyl methacrylate, nonyl methacrylate, lauryl methacrylate, cyclohexyl methacrylate, isodecyl methacrylate, propyl methacrylate, phenyl methacrylate, and isobornyl methacrylate; alkyl acrylates having 1-12 carbon atoms in the alkyl group, such as, methyl acrylate, ethyl acrylate, propyl acrylate, isopropyl acrylate, butyl acrylate, isobutyl acrylate, hexyl acrylate, 2-ethylhexyl acrylate, nonyl acrylate, lauryl acrylate, cyclohexyl acrylate, isodecyl acrylate, phenyl acrylate, and isobornyl acrylate; styrene; alkyl substituted styrene, such as, α-methyl styrene, t-butyl styrene, and vinyl toluene. Other examples of suitable acrylic polymers may include ROBOND™ PS-90, ROBOND™ PS-2000, ROBOND™ PS-7860, ROBOND™ DF-9850, all of which are available from The Dow Chemical Company, or ACRONAL™ V-215, available from BASF Corporation.

In some embodiments, the pressure sensitive adhesive may comprise an acrylic polymer suspended in one or more carriers. The pressure sensitive adhesive may contain 25-90 percent of one or more carriers based on the total weight of the pressure sensitive adhesive, in order to deliver the acrylic resin through a coating method. The carriers may include but are not limited to water or solvents, such as, ethyl acetate, toluene, and methyl ethyl ketone.

In some embodiments, the pressure sensitive adhesive may comprise an acrylic polymer emulsified with one or more suitable surfactants in percentages from 0.1-6%, based on acrylic monomer. Examples of suitable surfactants may include, but are not limited to, ethoxylated alcohols; sulfonated, sulfated and phosphated alkyl, aralkyl and alkaryl anionic surfactants; alkyl succinates; alkyl sulfosuccinates; and N-alkyl sarcosinates. Representative surfactants are the sodium, potassium, magnesium, ammonium, and the mono-, di- and triethanolamine salts of alkyl and aralkyl sulfates, as well as the salts of alkaryl sulfonates. The alkyl groups of the surfactants may have a total of from about twelve to twenty-one carbon atoms, may be unsaturated, and, in some embodiments, are fatty alkyl groups. The sulfates may be sulfate ethers containing one to fifty ethylene oxide or propylene oxide units per molecule. In some embodiments, the sulfate ethers contain two to three ethylene oxide units. Other representative surfactants may include sodium lauryl sulfate, sodium lauryl ether sulfate, ammonium lauryl sulfate, triethanolamine lauryl sulfate, sodium C₁₄₋₁₆ olefin sulfonate, ammonium pareth-25 sulfate, sodium myristyl ether sulfate, ammonium lauryl ether sulfate, disodium monooleamidosulfosuccinate, ammonium lauryl sulfosuccinate, sodium dodecylbenzene sulfonate, sodium dioctyl sulfosucciniate, triethanolamine dodecylbenzene sulfonate, and sodium N-lauroyl sarcosinate.

Further examples of suitable surfactants may include the TERGITOL™ surfactants from The Dow Chemical Company, Midland, Mich.; SPAN™ 20, a nonionic surfactant, from Croda International, Snaith, East Riding of Yorkshire, UK., for Sorbitan Monolaurate; ARLATONE™ T, a nonionic surfactant, from Croda International, Snaith, East Riding of Yorkshire, UK., for polyoxyethylene 40 sorbitol septaoleate, i.e., PEG-40 Sorbitol Septaoleate; TWEEN™ 28, a nonionic surfactant, from Croda International, Snaith, East Riding of Yorkshire, UK., for polyoxyethylene 80 sorbitan laurate, i.e., PEG-80 Sorbitan Laurate; products sold under the tradenames or trademarks such as EMCOL™ and WITCONATE™ by AkzoNobel, Amsterdam, The Netherlands.; MARLON™ by Sasol, Hamburg Germany.; AEROSOL™ by Cytec Industries Inc, Woodland Park, N.J.; HAMPOSYL™ The Dow Chemical Company, Midland, Mich.; and sulfates of ethoxylated alcohols sold under the tradename STANDAPOL™ by BASF.

The pressure sensitive adhesive may further comprise an additive. Suitable additives may include rheology modifiers (0 to 3%), defoamers (0 to 1%), tackifiers (0-50%), plasticizers (0-20%), fillers (0 to 40%). Tackifiers that are particularly useful include dispersed hydrocarbons and rosins (for example, TACOLYN™ 3100, available from the Eastman Chemical Company, Kingsport Tenn.).

In other embodiments, the pressure sensitive adhesive is a composition comprising an ethylene/α-olefin block copolymer and a tackifier, wherein the composition has a melt index (I₂) from 1 to 50 (190° C. and 2.16 kg) and an I₁₀/I₂ ratio from 7.5 to 13. As used herein, “composition” includes material(s) which comprise the composition, as well as reaction products and decomposition products formed from the materials of the composition.

In embodiments herein, the composition may have a density of from 0.850 g/cc to 0.910 g/cc. All individual values and subranges of from 0.850 g/cc to 0.910 g/cc are included and disclosed herein. For example, in some embodiments, the composition may have a density of from 0.860 g/cc to 0.900 g/cc. In other embodiments, the composition may have a density of from 0.870 g/cc to 0.890 g/cc.

In embodiments herein, the composition has a melt index (I₂) from 1 to 50 (190° C. and 2.16 kg) and an I₁₀/I₂ ratio from 7.5 to 13. All individual values and subranges of a melt index (I₂) from 1 to 50 (190° C. and 2.16 kg) and an I₁₀/I₂ ratio from 7.5 to 13 are included and disclosed herein. For example, in some embodiments, the melt index (I₂) may range from 1 to 40 g/10 min, from 1 to 30 g/10 min, or from 1 to 20 g/10 min. In other embodiments, the melt index (I₂) may range from 2 to 50 g/10 min., from 3 to 50 g/10 min, from 4 to 50 g/10 min., or from 5 to 50 g/10 min. Similarly, in some embodiments, the I₁₀/I₂ ratio may range from 7.6 to 13, or from 8.0 to 11. In other embodiments, the I₁₀/I₂ ratio may range from 7.7 to 13, from 8.0 to 12, or from 8.2 to 11. In further embodiments, the composition may have a melt index (I₂) from 2-50, 3-50, 4-50, 5-50, 1-40, 1-30 or 1-20 g/10 min and an I₁₀/I₂ ratio from 7.6-13, 7.7-13, 8.0-12, 8.0-11, or 8.2-11.

In embodiments herein, the composition may have a glass transition temperature (Tg) from −70° C. to −20° C., from −65° C. to −30° C., or from −62° C. to −40° C., as determined by DSC. In embodiments herein, the composition may have a melting temperature (Tm) from 110° C. to 130° C., from 112° C. to 125° C., or from 115° C. to 122° C., as determined by DSC. In embodiments herein, the composition may have a crystallization temperature (Tc) from 100° C. to 120° C., from 102° C. to 118° C., or from 104° C. to 115° C., as determined by DSC. In embodiments herein, the composition may have a delta heat of crystallization from 15 J/g to 35 J/g, from 16 J/g to 32 J/g, or from 17 J/g to 30 J/g, as determined by DSC.

In embodiments herein, the composition may have a storage modulus (G′ at 25° C.) from 0.4×10⁷ to 3.0×10⁷ dyne/cm², from 0.5×10⁷ to 2.5×10⁷ dyne/cm², or from 0.5×10⁷ to 2.0×10⁷ dyne/cm², as determined by DMA.

The ethylene/α-olefin block copolymer may be present in an amount greater than or equal to 50 weight percent, based on the weight of the composition. In some embodiments, the ethylene/α-olefin block copolymer may be present in an amount greater than or equal to 55 weight percent, or greater than or equal to 60 weight percent, based on the weight of the composition. In other embodiments, the ethylene/α-olefin block copolymer may be present in an amount from 50 to 95 weight percent, from 60 to 90 weight percent, from 65 to 85 weight percent, or from 70 to 85 weight percent, based on the weight of the composition.

The tackifier may be present in an amount less than or equal to 40 weight percent, based on the weight of the composition. In some embodiments, the tackifier may be present in an amount less than or equal to 35 weight percent. In other embodiments, the tackifier may be present in an amount from 5 to 30 weight percent, from 7 to 25 weight percent, or from 9 to 20 weight percent, based on the weight of the composition. In some embodiments, the amount of ethylene/α-olefin block copolymer, in the composition, is greater than the amount of tackifier, in the composition.

A. Ethylene/α-Olefin Block Copolymer

As used herein, the terms “ethylene/α-olefin block copolymer,” “olefin block copolymer,” or “OBC,” mean an ethylene/α-olefin multi-block copolymer, and includes ethylene and one or more copolymerizable α-olefin comonomer in polymerized form, characterized by multiple blocks or segments of two or more polymerized monomer units, differing in chemical or physical properties. The terms “interpolymer” and “copolymer” may be used interchangeably, herein, for the term ethylene/α-olefin block copolymer, and similar terms discussed in this paragraph. When referring to amounts of “ethylene” or “comonomer” in the copolymer, it is understood that this means polymerized units thereof. In some embodiments, the multi-block copolymer can be represented by the following formula:

(AB)ₙ,

where n is at least 1, or an integer greater than 1, such as 2, 3, 4, 5, 10, 15, 20, 30, 40, 50, 60, 70, 80, 90, 100, or higher; “A” represents a hard block or segment; and “B” represents a soft block or segment. In some embodiments, As and Bs are linked in a substantially linear fashion, as opposed to a substantially branched or substantially star-shaped fashion. In other embodiments, A blocks and B blocks are randomly distributed along the polymer chain. In other words, the block copolymers usually do not have a structure as follows:

AAA-AA-BBB-BB.

In still other embodiments, the block copolymers do not usually have a third type of block, which comprises different comonomer(s). In yet other embodiments, each of block A and block B has monomers or comonomers substantially randomly distributed within the block. In other words, neither block A nor block B comprises two or more sub-segments (or sub-blocks) of distinct composition, such as a tip segment, which has a substantially different composition than the rest of the block.

Ethylene may comprise the majority mole fraction of the whole block copolymer, i.e., ethylene comprises at least 50 mole percent of the whole polymer. In some embodiments, ethylene comprises at least 60 mole percent, at least 70 mole percent, or at least 80 mole percent, with the substantial remainder of the whole polymer comprising at least one other comonomer that may be an α-olefin having 3 or more carbon atoms. In some embodiments, the olefin block copolymer may comprise 50 mol. % to 90 mol. % ethylene, or 60 mol. % to 85 mol. %, or 65 mol. % to 80 mol. %. For many ethylene/octene block copolymers, the composition may comprise an ethylene content greater than 80 mole percent of the whole polymer and an octene content from 10 to 15, or from 15 to 20 mole percent of the whole polymer.

The olefin block copolymer includes various amounts of “hard” and “soft” segments. “Hard” segments are blocks of polymerized units, in which ethylene is present in an amount greater than 95 weight percent, or greater than 98 weight percent, based on the weight of the polymer, up to 100 weight percent. In other words, the comonomer content (content of monomers other than ethylene) in the hard segments is less than 5 weight percent, or less than 2 weight percent based on the weight of the polymer, and can be as low as zero. In some embodiments, the hard segments include all, or substantially all, units derived from ethylene. “Soft” segments are blocks of polymerized units in which the comonomer content (content of monomers other than ethylene) is greater than 5 weight percent, or greater than 8 weight percent, greater than 10 weight percent, or greater than 15 weight percent, based on the weight of the polymer. In some embodiments, the comonomer content in the soft segments can be greater than 20 weight percent, greater than 25 weight percent, greater than 30 weight percent, greater than 35 weight percent, greater than 40 weight percent, greater than 45 weight percent, greater than 50 weight percent, or greater than 60 weight percent, and can be up to 100 weight percent.

The soft segments can be present in an OBC from 1 weight percent to 99 weight percent of the total weight of the OBC, or from 5 weight percent to 95 weight percent, from 10 weight percent to 90 weight percent, from 15 weight percent to 85 weight percent, from 20 weight percent to 80 weight percent, from 25 weight percent to 75 weight percent, from 30 weight percent to 70 weight percent, from 35 weight percent to 65 weight percent, from 40 weight percent to 60 weight percent, or from 45 weight percent to 55 weight percent of the total weight of the OBC. Conversely, the hard segments can be present in similar ranges. The soft segment weight percentage and the hard segment weight percentage can be calculated based on data obtained from DSC or NMR. Such methods and calculations are disclosed in, for example, U.S. Pat. No. 7,608,668, entitled “Ethylene/α-Olefin Block Interpolymers,” filed on Mar. 15, 2006, in the name of Colin L. P. Shan, Lonnie Hazlitt, et al., and assigned to Dow Global Technologies Inc., the disclosure of which is incorporated by reference herein in its entirety. In particular, hard and soft segment weight percentages and comonomer content may be determined as described in Column 57 to Column 63 of U.S. Pat. No. 7,608,668.

The olefin block copolymer is a polymer comprising two or more chemically distinct regions or segments (referred to as “blocks”) that may be joined in a linear manner, that is, a polymer comprising chemically differentiated units, which are joined end-to-end with respect to polymerized ethylenic functionality, rather than in pendent or grafted fashion. In an embodiment, the blocks differ in the amount or type of incorporated comonomer, density, amount of crystallinity, crystallite size attributable to a polymer of such composition, type or degree of tacticity (isotactic or syndiotactic), regio-regularity or regio-irregularity, amount of branching (including long chain branching or hyper-branching), homogeneity or any other chemical or physical property. Compared to block interpolymers of the prior art, including interpolymers produced by sequential monomer addition, fluxional catalysts, or anionic polymerization techniques, the present OBC is characterized by unique distributions of both polymer polydispersity (PDI or Mw/Mn or MWD), block length distribution, and/or block number distribution, due, in an embodiment, to the effect of the shuttling agent(s) in combination with multiple catalysts used in their preparation.

In some embodiments, the OBC is produced in a continuous process and may possess a polydispersity index, PDI (or MWD), from 1.7 to 3.5, or from 1.8 to 3, or from 1.8 to 2.5, or from 1.8 to 2.2. When produced in a batch or semi-batch process, the OBC may possess a PDI from 1.0 to 3.5, or from 1.3 to 3, or from 1.4 to 2.5, or from 1.4 to 2.

In addition, the olefin block copolymer possesses a PDI fitting a Schultz-Flory distribution rather than a Poisson distribution. The present OBC has both a polydisperse block distribution as well as a polydisperse distribution of block sizes. This results in the formation of polymer products having improved and distinguishable physical properties. The theoretical benefits of a polydisperse block distribution have been previously modeled and discussed in Potemkin, Phys. Rev. E (1998) 57 (6), pp. 6902-6912, and Dobrynin, J. Chem. Phvs. (1997) 107 (21), pp 9234-9238. In some embodiments, the present olefin block copolymer possesses a most probable distribution of block lengths.

In some embodiments, the olefin block copolymer is defined as having:

(A) Mw/Mn from 1.7 to 3.5, at least one melting point, Tm, in degrees Celsius, and a density, d, in grams/cubic centimeter, where in the numerical values of Tm and d correspond to the relationship:

Tm>−2002.9+4538.5(d)−2422.2(d)², and/or

(B) Mw/Mn from 1.7 to 3.5, and is characterized by a heat of fusion, ΔH in J/g, and a delta quantity, ΔT, in degrees Celsius, defined as the temperature difference between the tallest DSC peak and the tallest Crystallization Analysis Fractionation (“CRYSTAF”) peak, wherein the numerical values of ΔT and ΔH have the following relationships:

ΔT>−0.1299ΔH+62.81 for ΔH greater than zero and up to 130 J/g

ΔT>48° C. for ΔH greater than 130 J/g
wherein the CRYSTAF peak is determined using at least 5 percent of the cumulative polymer, and if less than 5 percent of the polymer has an identifiable CRYSTAF peak, then the CRYSTAF temperature is 30° C.; and/or

(C) elastic recovery, Re, in percent at 300 percent strain and 1 cycle measured with a compression-molded film of the ethylene/α-olefin interpolymer, and has a density, d, in grams/cubic centimeter, wherein the numerical values of Re and d satisfy the following relationship when ethylene/α-olefin interpolymer is substantially free of cross-linked phase:

Re>1481−1629(d); and/or

(D) has a molecular fraction which elutes between 40° C. and 130° C. when fractionated using TREF, characterized in that the fraction has a molar comonomer content greater than, or equal to, the quantity (−0.2013)T+20.07, or, in some embodiments, greater than or equal to the quantity (−0.2013)T+21.07, where T is the numerical value of the peak elution temperature of the TREF fraction, measured in ° C.; and/or,

(E) has a storage modulus at 25° C., G′(25° C.), and a storage modulus at 100° C., G′(100° C.), wherein the ratio of G′(25° C.) to G′(100° C.) is in the range of 1:1 to 9:1.

The olefin block copolymer may also have:

(F) a molecular fraction which elutes between 40° C. and 130° C. when fractionated using TREF, characterized in that the fraction has a block index of at least 0.5 and up to 1, and a molecular weight distribution, Mw/Mn, greater than 1.3; and/or

(G) an average block index greater than zero and up to 1.0 and a molecular weight distribution, Mw/Mn greater than 1.3. It is understood that the olefin block copolymer may have one, some, all, or any combination of properties (A)-(G). Block Index can be determined as described in detail in U.S. Pat. No. 7,608,668, which is herein incorporated by reference for that purpose. Analytical methods for determining properties (A) through (G) are disclosed in, for example, U.S. Pat. No 7,608,668, Col. 31, line 26 through Col. 35, line 44, which is herein incorporated by reference for that purpose.

Suitable monomers for use in preparing the present OBC include ethylene and one or more additional polymerizable monomers other than ethylene. Examples of suitable comonomers include straight-chain or branched α-olefins of 3 to 30, or 3 to 20, carbon atoms, such as propylene, 1-butene, 1-pentene, 3-methyl-1-butene, 1-hexene, 4-methyl-1-pentene, 3-methyl-1-pentene, 1-octene, 1-decene, 1-dodecene, 1-tetradecene, 1-hexadecene, 1-octadecene and 1-eicosene; cycloolefins of 3 to 30, or 3 to 20, carbon atoms, such as cyclopentene, cycloheptene, norbornene, 5-methyl-2-norbornene, tetracyclododecene, and 2-methyl-1,4,5,8-dimethano-1,2,3,4,4a,5,8,8a-octahydronaphthalene; di- and polyolefins, such as butadiene, isoprene, 4-methyl-1,3-pentadiene, 1,3-pentadiene, 1,4-pentadiene, 1,5-hexadiene, 1,4-hexadiene, 1,3-hexadiene, 1,3-octadiene, 1,4-octadiene, 1,5-octadiene, 1,6-octadiene, 1,7-octadiene, ethylidenenorbornene, vinyl norbornene, dicyclopentadiene, 7-methyl-1,6-octadiene, 4-ethylidene-8-methyl-1,7-nonadiene, and 5,9-dimethyl-1,4,8-decatriene; and 3-phenylpropene, 4-phenylpropene, 1,2-difluoroethylene, tetrafluoroethylene, and 3,3,3-trifluoro-1-propene.

In some embodiments, the ethylene/α-olefin block copolymer has a density of from 0.850 g/cc to 0.900 g/cc, or from 0.855 g/cc to 0.890 g/cc or from 0.860 g/cc to 0.880 g/cc. In some embodiments, the ethylene/α-olefin block copolymer has a Shore A value of 40 to 70, from 45 to 65, or from 50 to 65. In some embodiments, the ethylene/α-olefin block copolymer has a melt index (MI or I₂) from 0.1 g/10 min to 50 g/10 min., or from 0.3 g/10 min. to 30 g/10 min, or from 0.5 g/10 min. to 20 g/10 min., as measured by ASTM D 1238 (190° C./2.16 kg).

In some embodiments, the ethylene/α-olefin block copolymer comprises polymerized ethylene and one α-olefin as the only monomer types. In other embodiments, the α-olefin is selected from propylene, 1-butene, 1-hexene or 1-octene. In further embodiments, the ethylene/α-olefin block copolymer excludes styrene. In even further embodiments, the ethylene/α-olefin block copolymer is an ethylene/octene block copolymer.

The ethylene/α-olefin block copolymers can be produced via a chain shuttling process, such as described in U.S. Pat. No. 7,858,706, which is herein incorporated by reference. In particular, suitable chain shuttling agents and related information are listed in Col. 16, line 39, through Col. 19, line 44. Suitable catalysts are described in Col. 19, line 45, through Col. 46, line 19, and suitable co-catalysts in Col. 46, line 20, through Col. 51 line 28. The process is described throughout the document, but particularly in Col. 51, line 29, through Col. 54, line 56. The process is also described, for example, in the following: U.S. Pat. Nos. 7,608,668; 7,893,166; and 7,947,793.

In other embodiments, the ethylene/α-olefin block copolymer has at least one of the following properties A through E:

(A) Mw/Mn from 1.7 to 3.5, at least one melting point, Tm, in degrees Celsius, and a density, d, in grams/cubic centimeter, wherein the numerical values of Tm and d correspond to the relationship: Tm>−2002.9+4538.5(d)−2422.2(d)², and/or

(B) Mw/Mn from 1.7 to 3.5, and is characterized by a heat of fusion, ΔH in J/g, and a delta quantity, ΔT, in degrees Celsius defined as the temperature difference between the tallest DSC peak and the tallest Crystallization Analysis Fractionation (“CRYSTAF”) peak, wherein the numerical values of ΔT and ΔH have the following relationships:

ΔT>−0.1299ΔH+62.81 for ΔH greater than zero and up to 130 J/g

ΔT≧48° C. for ΔH greater than 130 J/g
wherein the CRYSTAF peak is determined using at least 5 percent of the cumulative polymer, and if less than 5 percent of the polymer has an identifiable CRYSTAF peak, then the CRYSTAF temperature is 30° C.; and/or

(C) elastic recovery, Re, in percent at 300 percent strain and 1 cycle measured with a compression-molded film of the ethylene/α-olefin interpolymer, and has a density, d, in grams/cubic centimeter, wherein the numerical values of Re and d satisfy the following relationship when ethylene/α-olefin interpolymer is substantially free of crosslinked phase:

Re>1481−1629(d); and/or

(D) has a molecular fraction which elutes between 40° C. and 130° C. when fractionated using TREF, characterized in that the fraction has a molar comonomer content greater than, or equal to, the quantity (−0.2013)T+20.07, or greater than or equal to the quantity (−0.2013) T+21.07, where T is the numerical value of the peak elution temperature of the TREF fraction, measured in ° C.; and/or,

(E) has a storage modulus at 25° C., G′(25° C.), and a storage modulus at 100° C., G′(100° C.), wherein the ratio of G′(25° C.) to G′(100° C.) is in the range of 1:1 to 9:1.

It should be understood herein that the ethylene/α-olefin block copolymer may comprise a combination or two or more embodiments described herein.

B. Tackifier

In embodiments herein, the tackifier is a resin that is used to reduce modulus and improve surface adhesion. In some embodiments, the tackifier may be a non-hydrogenated aliphatic C₅ (five carbon atoms) resin, a hydrogenated aliphatic C₅ resin, an aromatic-modified C₅ resin, a terpene resin, a hydrogenated C₉ resin, or combinations thereof. The C₅ resin may be obtained from C₅ feedstocks, such as, pentenes and piperylene. The terpene resin may be based on pinene and d-limonene feedstocks. The hydrogenated resin may be based on aromatic resins, such as, C₉ feedstocks, rosins, aliphatic or terpene feedstocks. Nonlimiting examples of suitable tackifier include tackifiers sold under the tradename PICCOTAC™, REGALITE™, REGALREZ™, and PICCOLYTE™. Specific examples of suitable tackifiers include PICCOTAC™ 1100, REGALITE™ R1090, REGALREZ™ 1094, which are available from The Eastman Chemical Company, and PICCOLYTE™ F-105 available from Pinova, Inc. In some embodiments, the tackifier may comprise a combination or two or more tackifiers described herein.

In some embodiments, the tackifier is selected from the group consisting of a non-hydrogenated aliphatic C₅ resin, a hydrogenated aliphatic C₅ resin, an aromatic modified C₅ resin, a terpene resin, a non-hydrogenated C₉ resin, a hydrogenated C₉ resin, and combinations thereof. In other embodiments, the tackifier is selected from the group consisting of a non-hydrogenated aliphatic C₅ resin, a hydrogenated aliphatic C₅ resin, a non-hydrogenated C₉ resin, a hydrogenated C₉ resin, and combinations thereof.

In some embodiments, the tackifier may have a density ranging from 0.92 g/cc to 1.06 g/cc. Of course, all individual values and subranges of from 0.92 g/cc to 1.06 g/cc are included and disclosed herein.

In some embodiments, the tackifier may have a Ring and Ball softening temperature (measured in accordance with ASTM E 28) from 80° C. to 140° C., or from 85° C. to 130° C. or from 90° C. to 120° C., or from 90° C. to 100° C. In other embodiments, the tackifier may have a Ring and Ball softening temperature (measured in accordance with ASTM E 28) from 85° C. to 135° C., from 90° C. to 130° C., or from 90° C. to 125° C. In further embodiments, the tackifier may have a Ring and Ball softening temperature (measured in accordance with ASTM E 28) from 80° C. to 120° C., from 85° C. to 115° C., or from 90° C. to 110° C.

In some embodiments, the tackifier has a melt viscosity of less than 1000 Pascal second (Pa·s) at 175° C. All individual values and subranges of less than 1000 Pascal second (Pa·s) at 175° C. are included and disclosed herein. For example, in some embodiments, the tackifier has a melt viscosity of less than 500 Pa·s at 175° C., less than 200 Pa·s at 175° C., less than 100 Pa·s at 175° C., or less than 50 Pa·s at 175° C. In other embodiments, the tackifier has a melt viscosity greater than, or equal to, 1 Pascal second (Pa·s) at 175° C., or greater than, or equal to, 5 Pascal second (Pa·s) at 175° C. In further embodiments, the tackifier has a melt viscosity from 1 Pa·s to less than 100 Pa·s, or from 1 Pa·s to less than 50 Pa·s at 175° C.

C. Oil

The composition may further comprise an oil. In some embodiments, the oil contains greater than 95 mol. % aliphatic carbons. In some embodiments, the glass transition temperature for the amorphous portion of the oil is below −70° C. The oil can be a mineral oil. Nonlimiting examples of suitable oils may include mineral oils sold under the tradenames HYDROBRITE™ 550 (Sonnebom), PARALUX™ 6001 (Chevron), KAYDOL™ (Sonnebom), BRITOL™ 50T (Sonneborn), CLARION™ 200 (Citgo), and CLARION™ 500 (Citgo). The oil may comprise a combination or two or more embodiments described herein. The oil may be present in an amount from 2 to 25 weight percent, from 4 to 20 weight percent, or from 6 to 15 weight percent, based on the weight of the composition.

D. Additives

The composition may further comprise one or more additives. Examples of suitable additives may include, but are not limited to, antioxidants, ultraviolet absorbers, antistatic agents, pigments, viscosity modifiers, anti-block agents, release agents, fillers, coefficient of friction (COF) modifiers, induction heating particles, odor modifiers/absorbents, and any combination thereof. In some embodiments, the composition further comprises one or more additional polymers. Additional polymers include, but are not limited to, ethylene-based polymers and propylene-based polymers.

In embodiments herein, the pressure sensitive adhesive may have a 180° peel from stainless steel after a 24 hour dwell time (according to test method PSTC 101@50% R.H., 23° C.) of from 0.25 N-6 N. All individual values and subranges of from 0.25 N-6 N are included and disclosed herein. For example, in some embodiments, the pressure sensitive adhesive may have a 180° peel from stainless steel after a 24 hour dwell time (according to test method PSTC 101@50% R.H., 23° C.) of from 0.5 N-5 N. In other embodiments, the pressure sensitive adhesive may have a 180° peel from stainless steel after a 24 hour dwell time (according to test method PSTC 101@50% R.H., 23° C.) of from 1 N-5 N.

Outermost Release Layer

The outermost release layer is configured to provide a poor adhesion surface for the outermost adhesive layer. In embodiments herein, the outermost release layer may have a thickness of from 0.05-6.0 mils. All individual values and subranges of from 0.05-6.0 mils are included and disclosed herein. For example, in some embodiments, the outermost adhesive layer may have a thickness of from 0.05-3.0 mils. In other embodiments, the outermost adhesive layer may have a thickness of from 0.05-1.0 mils. In further embodiments, the outermost adhesive layer may have a thickness of from 0.1-0.75 mils. In even further embodiments, the outermost adhesive layer may have a thickness of from 0.1-0.5 mils.

The outermost release layer comprises a release material and, optionally, a release agent. The release material is a coating comprising a base resin having a surface energy less than 35 dynes/cm. All individual values and subranges of less than 35 dynes/cm are included and disclosed herein. For example, in some embodiments, the release material comprises a base resin having a surface energy less than 25 dynes/cm. In other embodiments, the release material comprises a base resin having a surface energy of 28-40 dynes/cm. In further embodiments, the release material comprises a base resin having a surface energy of 28-35 dynes/cm. The surface energy of suitable release materials can be determined by the Owens-Wendt equation, given below, and measuring advancing contact angles of bromonapthalene and water. Five drops of each liquid would be used. The solvent parameters are water total energy 72.8 mN/m, dispersive energy 21.8 mN/m and bromonapthalene total energy 44.4 mN/m and dispersive energy 44.4 mN/m. The Owens-Wendt equation is as follows:

$$\frac{{σ }_{L} ( cos θ + 1 )}{2 \sqrt{{σ}_{L}^{D}}} = \frac{\sqrt{{σ}_{S}^{P}} \sqrt{{σ}_{L}^{P}}}{\sqrt{{σ}_{L}^{D}}} + \sqrt{{σ}_{S}^{D}}$$

wherein σ is surface tension, D is dispersive component, P is polar component, L is liquid, S is solid.

The base resin may comprise low density polyethylene (LDPE), linear low density polyethylene (LLDPE), medium density polyethylene (MDPE), high density polyethylene (HDPE), polypropylene (PP), silicone resin, or combinations thereof. In some embodiments, the base resin comprises an LDPE. In some embodiments, the base resin comprises an HDPE. In other embodiments, the base resin comprises an HDPE without a release agent. In some embodiments, the base resin comprises polypropylene. In other embodiments, the base resin comprises polypropylene without a release agent. In some embodiments, the base resin comprises a silicone resin.

“LDPE” may also be referred to as “high pressure ethylene polymer” or “highly branched polyethylene” and includes polymers that are partly or entirely homopolymerized or copolymerized in autoclave or tubular reactors at pressures above 14,500 psi (100 MPa) with the use of free-radical initiators, such as peroxides (see for example U.S. Pat. No. 4,599,392, herein incorporated by reference). The process results in a polymer architecture characterized by many long chain branches, including branching on branches. LDPE resins typically have a density in the range of 0.916 to 0.940 g/cm³. Examples of LDPE resins include the ExxonMobil LD series resins, and the LDPE series of resins available from Dow Chemical.

“LLDPE” refers to both linear and substantially linear low density resins having a density in the range of from about 0.855 g/cm³ to about 0.925 g/cm³. “LLDPE” may be made using chromium, Ziegler-Natta, metallocene, constrained geometry, or single site catalysts. The term “LLDPE” includes znLLDPE, uLLDPE, and mLLDPE. “znLLDPE” refers to linear polyethylene made using Ziegler-Natta or chromium catalysts and typically has a density of from about 0.912 to about 0.925 and a molecular weight distribution greater than about 2.5, “uLLDPE” or “ultra linear low density polyethylene” refers to linear polyethylene made using chromium or Ziegler-Natta catalysts and typically having a density of less than 0.912 g/cm³ and a molecular weight distribution (“MWD”) greater than 2.5, and “mLLDPE” refers to LLDPE made using metallocene, constrained geometry, or single site catalysts and typically has a density in the range of from about 0.855 to 0.925 g/cm³ and a molecular weight distribution (“MWD”) in the range of from 1.5 to 8.0.

“MDPE” refers to linear polyethylene having a density in the range of from greater than 0.925 g/cm³ to about 0.940 g/cm³ and typically has a molecular weight distribution (“MWD”) greater than 2.5. “MDPE” is typically made using chromium or Ziegler-Natta catalysts or using metallocene, constrained geometry, or single cite catalysts. “HDPE” refers to linear polyethylene having a density in the range greater than or equal to 0.940 g/cm³ and typically has a molecular weight distribution (“MWD”) greater than 2.5. “HDPE” is typically made using chromium or Ziegler-Natta catalysts or using metallocene, constrained geometry, or single cite catalysts.

“Polypropylene” refers to polymers comprising greater than 50%, by weight, of units derived from propylene monomer. This includes homopolymer polypropylene, random copolymer polypropylene, and impact copolymer polypropylene. These polypropylene materials are generally known in the art. “Polypropylene” also includes the relatively newer class of polymers known as propylene-based plastomers or elastomers (“PBE” of “PBPE”). These propylene/alpha-olefin copolymers are further described in details in the U.S. Pat. Nos. 6,960,635 and 6,525,157, incorporated herein by reference. Such propylene/alpha-olefin copolymers are commercially available from The Dow Chemical Company, under the tradename VERSIFY™, or from ExxonMobil Chemical Company, under the tradename VISTAMAXX™.

“Silicone resin” refers to silicone based polymers, such as those described in U.S. Pat. No. 2,588,367, which is incorporated herein by reference.

In some embodiments, a surface of the outermost release layer comprises at least one of a plurality of three-dimensional protrusions, a plurality of three-dimensional apertures, or combinations thereof. The three-dimensional protrusions or apertures form a release surface on the surface of the outermost release layer. The three-dimensional protrusions may be produced using any suitable process, such as, by an embossing process, a hydroforming process, a vacuum forming process, or other suitable surface roughening processes. The three-dimensional apertures may be produced using any suitable process, such as, by embossing, molding, stamping, foaming, or other suitable methods known in the art. Exemplary embossing processes may be found in U.S. Pat. Nos. 6,669,347 or 7,101,437, which are herein incorporated by reference. Exemplary foaming processes may be found in U.S. Pat. Nos. 3,760,940, 3,950,480, 4,844,852, 6,126,013, 6,254,965, 2011/0117326, and 2013/0029104, which are herein incorporated by reference. The three-dimensional protrusions and/or apertures may have a cross-section that is circular, oval, triangular, square, pentagonal, hexagonal, or any other desired shape. The pattern of the three-dimensional protrusions and/or apertures may exist in either a regular geometric array or a random array. It should be understood that the amount, protrusion height, aperture diameter and shape, pattern, etc. of three-dimensional protrusions and/or apertures present on the surface of the outermost release layer can be varied in such a manner to reduce the amount of surface contact with the outermost release layer and/or to maintain a surface energy that is less than 35 dynes/cm.

As noted above, the outermost release layer may further comprise an optional release agent. The optional release agent may be present in the release material in amounts of 500 ppm to 20,000 ppm, 1,000 ppm to 15,000 ppm, or 2,000 ppm to 10,000 ppm. Suitable release agents include agents that can lower the surface energy of the base resin, while not allowing the migration of contaminants to the surface of the outermost release layer, which may affect the pressure sensitive adhesive present in the outermost adhesive layer. Examples of suitable optional release agents may include, but are not limited to, silica, silicone, siloxane, calcium carbonate, talc, or ethylene ethyl acrylate, or combinations thereof. Other examples of suitable release agents may include RAC0500, available from Polyfil Corporation, Ampacet 10053, Ampacet 102777, and Dow Corning MB50-002.

The total thickness of the cling foils described herein may range from 0.5-8 mils. All individual values and subranges of from 0.5-8 mils are included and disclosed herein. For example, in some embodiments, the cling foil may have a thickness of from 0.5-5 mils. In other embodiments, the cling foil may have a thickness of from 0.5-4 mils. In further embodiments, the cling foil may have a thickness of from 0.5-2 mils. In even further embodiments, the cling foil may have a thickness of from 1-3 mils.

The cling foils described herein are suitable for use in food applications. The cling foils may be formed into a cling foil roll and inserted into a box. The cling foil roll may be capable of adhering to itself and/or to the surface of a substrate, such as, for example, glass, plastic, ceramic, stainless steel, laminated cardboard, and aluminum, while also providing a release surface to reduce the tendency of the cling foil to adhere to itself when in roll form.

Also described herein are methods of manufacturing a cling foil. The methods comprise providing a foil layer having a first side and a second side, forming an outermost adhesive layer, directly or indirectly, onto the first side of the foil layer, and forming an outermost release layer, directly or indirectly, onto the second side of the foil layer, wherein the outermost adhesive layer, foil layer, and outermost release layer together form a cling foil.

The outermost adhesive layer and the outermost release layer may be formed by methods known in the art, and can include, for example, by extrusion coating, or standard aqueous coating techniques, such as, curtain, gravure, wire wound rod, knife over roll, or flexographic. In some embodiments, the outermost adhesive layer and the outermost release layer are formed by extrusion coating. The outermost adhesive layer and outermost release layer may be formed simultaneously, or alternatively, may be formed sequentially. The outermost release layer may be formed by a matte or embossed chill roll as part of an extrusion coating process. Alternatively, the outermost release layer may be modified after coating using a separate matte or embossing setup.

The following analytical methods are used in the present invention:

Differential Scanning Calorimetry (DSC) for Crystallinity (Inventive Example 1)

Differential Scanning Calorimetry (DSC) is used to measure crystallinity in the ethylene (PE)-based polymer samples and propylene (PP)-based polymer samples. About five to eight milligrams of a sample is weighed and placed in a DSC pan. The lid is crimped on the pan to ensure a closed atmosphere. The sample pan is placed in a DSC cell, and then heated, at a rate of approximately 10° C./min, to a temperature of 180° C. for PE (or 230° C. for PP). The sample is kept at this temperature for three minutes. Then the sample is cooled at a rate of 10° C./min to −60° C. for PE (or -40° C. for PP), and kept isothermally at that temperature for three minutes. The sample is next heated at a rate of 10° C./min, until complete melting (second heat). For polymer samples (not formulations), the percent crystallinity is calculated by dividing the heat of fusion (H_{f} or ΔH melting), determined from the second heat curve, by a theoretical heat of fusion of 292 J/g for PE (or 165 J/g, for PP), and multiplying this quantity by 100 (e.g., for PE, % cryst.=(H_{f}/292 J/g)×100; and for PP, % cryst.=(H_{f}/165 J/g)×100).

Unless otherwise stated, melting point(s) (Tₘ) of each polymer is determined from the second heat curve obtained from DSC, as described above (peak Tm). The glass transition temperature (T_{g}) is determined from the second heating curve (midpoint). The crystallization temperature (T_{c}) is measured from the first cooling curve (peak Tc). The Delta H of crystallization was obtained from the first cooling curve and is calculated by integrating the area under the crystallization peak. The Delta H of melting was obtained from the second heat curve and is calculated by integrating the area under the melting peak.

Differential Scanning Calorimetry (DSC) for Glass Transition Temperature (Inventive Example 2)

Glass transition temperatures are determined in accordance with ASTM-E-1356 using the midpoint as the glass transition temperature and a heating rate of 10° C./min

Melt Index

Melt index for an ethylene-based polymer, or formulation, is measured in accordance with ASTM D 1238, condition 190° C./2.16 kg for I₂, and 190° C./10 kg for I₁₀. While melt flow rate (MFR) for a propylene-based polymer is measured in accordance with ASTM D1238, condition 230° C./2.16 kg.

Density

Samples (polymers and formulations) for density measurement are prepared according to ASTM D 1928. Measurements are made within one hour of sample pressing using ASTM D792, Method B.

GPC Method

The gel permeation chromatographic system consists of either a Polymer Laboratories Model PL-210 or a Polymer Laboratories Model PL-220 instrument. The column and carousel compartments are operated at 140° C. Three Polymer Laboratories 10-micron Mixed-B columns are used. The solvent is 1,2,4 trichlorobenzene. The samples are prepared at a concentration of 0.1 grams of polymer in 50 milliliters of solvent containing 200 ppm of butylated hydroxytoluene (BHT). Samples are prepared by agitating lightly for 2 hours at 160° C. The injection volume is 100 microliters and the flow rate is 1.0 ml/minute.

Calibration of the GPC column set is performed with 21 narrow molecular weight distribution polystyrene standards with molecular weights ranging from 580 to 8,400,000 g/mole, arranged in six “cocktail” mixtures, with at least a decade of separation between individual molecular weights. The standards are purchased from Polymer Laboratories (Shropshire, UK). The polystyrene standards are prepared at “0.025 grams in 50 milliliters of solvent” for molecular weights equal to, or greater than, 1,000,000 g/mole, and “0.05 grams in 50 milliliters of solvent” for molecular weights less than 1,000,000 g/mole. The polystyrene standards are dissolved at 80° C. with gentle agitation for 30 minutes. The narrow standards mixtures are run first, and in order of decreasing highest molecular weight component, to minimize degradation. The polystyrene standard peak molecular weights are converted to polyethylene molecular weights using the following equation (as described in Williams and Ward, J. Polym. Sci., Polym. Let., 6, 621 (1968)): M_{polyethylene}=0.431(M_{polystyrene}). Polyethylene equivalent molecular weight calculations are performed using VISCOTEK TriSEC software Version 3.0.

Dynamic Mechanical Analysis (DMA)

For the polyolefin-based pressure sensitive adhesives, Dynamic Mechanical Analysis (DMA) is measured on compression molded disks formed in a hot press at 180° C. at 10 MPa pressure for five minutes, and then water cooled in the press at 90° C./min. Testing is conducted using an ARES controlled strain rheometer (TA instruments) equipped with dual cantilever fixtures for torsion testing.

For acrylic-based pressure sensitive adhesives, the liquid sample is air dried for 2 weeks in a TEFLON™ dish and then dried in a vacuum oven at room temperature overnight. The plaque is then removed from the tray and is 1.5 mm in thickness.

For the polyolefin-based pressure sensitive adhesive sample, a “1.5 mm plaque” is pressed, and for both of the pressure sensitive adhesive samples, the plaque is cut in a bar of dimensions 32 mm×12 mm (test sample). The test sample is clamped at both ends between fixtures separated by 10 mm (grip separation ΔL), and subjected to successive temperature steps from −100° C. to 200° C. (5° C. per step). At each temperature, the shear elastic modulus, G′, is measured at an angular frequency of 6.3 rad/s, the strain amplitude being maintained between 0.1 percent and 4 percent, to ensure that the torque is sufficient and that the measurement remains in the linear regime.

An initial static force of 10 g is maintained (auto-tension mode) to prevent slack in the sample when thermal expansion occurred. As a consequence, the grip separation ΔL increases with the temperature, particularly above the melting or softening point of the polymer sample. The test stops at the maximum temperature or when the gap between the fixtures reaches 65 mm. The storage modulus is taken at 25° C.

Adhesion

All adhesive tests (180° Peel and Loop Tack) use a test specimen that is prepared by methods described below onto 0.4 mil aluminum foil, to form a film laminate. The final assembly is cut into “one inch by six inch” strips (bond area “1 inch×6 inch”) for 180° Peel tests and “one inch by five inch” strips (bond area “1 inch×5 inch”) for Loop Tack. The substrates used are standard stainless steel test panels obtained from Chemsultants and are cleaned using standard PSTC practices. HDPE panels are purchased from McMaster-Can Part# 8619K446 and cut into 2 inch by 6 inch pieces. Flat plate glass panels are purchased from Aldersfer Glass. White glazed ceramic 2 inch by 6 inch tile is purchased from Lowes and used to simulate ceramic surfaces. In order to simulate wood surfaces, pieces of maple are purchased from Lowes as ¼ inch thick 2 inch wide and 2 foot long pieces then they are cut down to 6 inch panels and used as is, no surface preparation is done. The overlap areas for 180° peel tests are placed on a roll down machine (Cheminstruments RD-3000) and passed over twice (once in each direction) with a 4.5 lb weight, at a rate of 12 inches per minute. An INSTRON Model 5564 with BlueHill v.3 software is used to complete all peel tests. All subsequent adhesive test methods are measured at controlled temperature and relative humidity (RH) (23° C. and 50% RH) conditions.

Peel Force is a measure of the force required to remove the adhesive coated film from the substrate. Peel force is measured after a 20 minute dwell time at 23° C./50% RH (Relative Humidity) or a 24 hour dwell time at 23° C./50% RH (Relative Humidity), after the lamination step. The failure modes are indicated with an “A” meaning the failure point is between the adhesive and substrate it was applied to.

Loop Tack

Loop tack is measured according to test method PSTC-16 (Test Methods for Pressure Sensitive Adhesive Tapes, 16^{th} edition) following Test Method A.

Surface Energy with Advancing Contact Angles

Contact angles are measured approximately 4 seconds after drop placement on a Kruss G10 goniometer. Angles are measured with T-1 tangent fit. At least 5 drops are taken on each sample; however, more drops are analyzed when the first 5 drops did not appear to give consistent readings.

Surface energies of solid samples are calculated using the Owens-Wendt equation on water, and diiodomethane contact angles. Use of formamide angles resulted in a poor fit. Angles are fit using Tangent-1 fitting. At least 5 angles are measured for each sample.

Contact angles on Teflon are used to calculate the polar and dispersive forces for each liquid using the following equation:

$${σ}_{L}^{D} = \frac{{{σ}_{L}^{2} ( cos {θ}_{PTFE} + 1 )}^{2}}{72}$$

Some embodiments of the present disclosure will now be described in detail in the following Examples.

### EXAMPLES

The inventive samples were prepared by extrusion coating of a release layer composition onto a first side of a foil and coating, by various methods, an adhesive layer onto a second side of the foil.

In Inventive Example 1, the release layer composition comprises 95 wt. % of LDPE having a density of 0.918 g/cc and a melt index, I₂, of 8 g/10 min. (LDPE 722, a product of The Dow Chemical Company, Midland, Mich.), and 5 wt. % of a release agent (RAC 0500, commercially available from PolyFil Corporation, Rockaway, N.J.). The adhesive layer comprises 83 wt. % of an ethylene-alpha-olefin block copolymer having a density of 0.866 g/cc and a melt index, I₂, of 15 (INFUSE™ 9807, a product of The Dow Chemical Company, Midland, Mich.), 12 wt. % of a tackifier (PICCOTAC™ 1100, commercially available from Eastman Chemical Company, Kingsport, Tenn.), and 5 wt. % of oil (HYDROBRITE™ 550, commercially available from Sonnebom, Parsippany, N.J.).

The compounding operation was performed on a 25-mm co-rotating twin screw extruder. The extruder had a total length-to-diameter ratio (L/D) of 48. The extruder was equipped with a 24 kW motor and a maximum screw speed of 1200 rpm. The screw speed was set at 300 RPM for all of the samples. The temperature profile was 100° C. (zone 1), 120° C. (zone 2), 140° C. (zone 3), 140° C. (zone 4), 110° C. (zone 5), 100° C. (zone 6), and 110° C. (zone 7). The feed system for this extrusion line consisted of two loss-in-weight feeders. The polymer was fed into the main feed throat of the extruder using a K-Tron Model KCLQX3 single-screw feeder.

The tackifier was fed into the side arm at barrel 5, which is the injection point in zone 5. The oil was added through an injection port at barrel 4 using a Leistritz Gear Pump. The compound was pelletized using an underwater pelletization unit with a 2-hole die. The pellets were collected and dusted with 2000 ppm POLYWAX™ 2000 (commercially available from Baker Hughes, Inc., Houston, Tex.) and then dried under nitrogen purge for 24 hours.

In Inventive Example 2, the release layer composition comprises 95 wt. % of LDPE having a density of 0.918 g/cc and a melt index, I₂, of 8 g/10 min. (LDPE 722, a product of The Dow Chemical Company, Midland, Mich.), and 5 wt. % of a release agent (RAC 0500, commercially available from PolyFil Corporation, Rockaway, N.J.). The adhesive layer comprises an acrylic water-based pressure sensitive adhesive (ROBOND™ PS-90, a product of The Dow Chemical Company, Midland, Mich.).

The extrusion coating line was used for the adhesive layer of Inventive Example 1 and the release layer for Inventive Examples 1 and 2. The extrusion coating line consists of a 3½ inch diameter primary extruder with a 30:1 L/D single flight screw and a co-extrusion feed block/die combination. A 36 inch coat hanger EBR (Edge Bead Reduction) die with a 0.020 inch (20 mil) die gap and a 6 inch air gap was used for all of the extrusion coating evaluations. Monolayer coating evaluations using the primary extruder were conducted with 0.4 mil aluminum foil and a matte finish, glycol cooled chill roll set at 57° F. The samples were extrusion coated at an extruder speed of 22 RPM (approximately 70 lbs/hr) at a melt temperature of 300° F. The samples were obtained at a 100 fpm line speed. The extrusion coating conditions of these samples are further summarized in Table I.

The adhesive layer in Inventive Example 2 was applied using two different methods. For samples of Inventive Example 2 with higher coat weights, ROBOND™ PS-90 was applied directly to the 0.4 mil aluminum foil plus release layer and metered off to the desired coat weight using a wire wound rod. The higher coat weight samples were dried in an 80° C. convection oven for 5 minutes. For samples of Inventive Example 2 with lower coat weights, ROBOND™ PS-90 was applied directly to the 0.4 mil aluminum foil plus release layer using an Egan pilot coater setup for reverse gravure with a gravure cylinder chosen to achieve 0.22 mil thickness of adhesive. The foil construction was coated at 75 feet per minute. The Egan pilot coater has a two zone drying oven where the first zone was set to 170° F. and the second to 180° F.

TABLE I
Extrusion Coating Conditions

| | Melt | | Back | Primary |
|---|---|---|---|---|
| | Temp | Extruder | Pressure | Extruder |
| | (° F.) | (Amps) | (psi) | (RPM) |
| Release Layer for | 550 | 65 | 400 | 22 |
| Inventive Examples 1 & 2 | | | | |
| Adhesive Layer for | 300 | 35 | 250 | 22 |
| Inventive Example 1 | | | | |

The peel strength adhesion and loop tack were measured for the inventive samples. Two measurements were made for the 20 min and 24 hour dwell 180 degree peel adhesion and two measurements were made for the loop tack. The measurements were averaged to obtain the numbers shown in Tables II and III below. In addition, the failure mode was marked with an “A” to indicate an adhesive failure between the adhesive and substrate it was applied to.

TABLE II
Adhesion and Loop Tack Measurements for Inventive Example 1

| | | Average 180° Peel Adhesion | Failure |
|---|---|---|---|
| | | (N/in) | Mode |
| | 20 Min. Dwell | | |
| 1 | Stainless Steel | 2.1 | A |
| 2 | HDPE | 0.5 | A |
| 3 | Glass | 0.5 | A |
| 4 | Ceramic | 1.7 | A |
| | 24 Hour Dwell | | |
| 1 | Stainless Steel | 3.5 | A |
| 2 | HDPE | 0.3 | A |
| 3 | Glass | 2.3 | A |
| 4 | Ceramic | 1.5 | A |

| | Loop Tack | Average Loop Tack (N/in²) |
|---|---|---|
| 1 | Stainless Steel | 0.2 |
| 2 | HDPE | 0.2 |
| 3 | Glass | 0.2 |
| 4 | Ceramic | 0.2 |

TABLE III
Adhesion and Loop Tack Measurements for Inventive Example 2

| | Coat | Stainless | | | | |
|---|---|---|---|---|---|---|
| | Weight | Steel | HDPE | Glass | Ceramic | Wood |
| Average 180° Peel | 1.1 mil | 6.1 A | 1.5 A | 4.6 A | 4.6 A | 6.9 A |
| Adhesion 24 Hour | | | | | | |
| Dwell (N/in) | | | | | | |
| Average Loop Tack | 1.1 mil | 9.5 A | 3.7 A | 8.1 A | 8.5 A | 5.9 A |
| (N/in²) | | | | | | |
| Average 180° Peel | 0.22 mil | 1.0 A | 0.3 A | 1.0 A | 1.1 A | 0.4 A |
| Adhesion 24 Hour | | | | | | |
| Dwell (N/in) | | | | | | |
| Average Loop Tack | 0.22 mil | 0.3 A | 0.5 A | 0.6 A | 0.6 A | 0.2 A |
| (N/in²) | | | | | | |

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

Every document cited herein, if any, including any cross referenced or related patent or application and any patent application or patent to which this application claims priority or benefit thereof, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

We claim:

1. A cling foil comprising:
an outermost adhesive layer comprising a pressure sensitive adhesive;
an outermost release layer, the outermost release layer comprising a release material, wherein the release material is a coating comprising a base resin having a surface energy less than 35 dynes/cm and a release agent; and
a foil layer positioned between the outermost adhesive layer and the outermost release layer.

2. The cling foil of claim 1, wherein the foil layer is an aluminum foil layer or an aluminum-alloy foil layer.

3. The cling foil of claim 1, wherein the thickness ratio of the foil layer to the outermost adhesive and release layers ranges from 1:5 to 10:1.

4. The cling foil of claim 1, wherein the pressure sensitive adhesive is an acrylic polymer.

5. The cling foil of claim 1, wherein the pressure sensitive adhesive is a composition comprising:
an ethylene/α-olefin block copolymer; and
a tackifier;
wherein the composition has a melt index (I₂) from 1 to 50 (190° C. and 2.16 kg) and an I₁₀/I₂ ratio from 7.5 to 13.

6. The cling foil of claim 5, wherein the composition further comprises an oil.

7. The cling foil of claim 1, wherein the thickness of the outermost adhesive layer ranges from 0.05 to 2 mils.

8. The cling foil of claim 1, wherein the pressure sensitive adhesive has a 180° peel from stainless steel after a 24 hour dwell time (according to test method PSTC 101@50% R.H., 23° C.) of from 0.25 N-6 N.

9. (canceled)

10. The cling foil of claim 1, wherein the base resin comprises LDPE, LLDPE, MDPE, HDPE, PP, or silicone resin, or combinations thereof.

11. The cling foil of claim 1, wherein the release agent comprises silica, silicone, calcium carbonate, talc, or ethylene ethyl acrylate, or combinations thereof.

12. The cling foil of claim 1, wherein a surface of the outermost release layer comprises at least one of a plurality of three-dimensional protrusions, a plurality of three-dimensional apertures, or combinations thereof.

13. A method of manufacturing a cling foil, the method comprising:
providing a foil layer having a first side and a second side;
forming an outermost adhesive layer comprising a pressure sensitive adhesive, directly or indirectly, onto the first side of the foil layer; and
forming an outermost release layer comprising a release material, wherein the release material is a coating comprising a base resin having a surface energy less than 35 dynes/cm and a release agent, directly or indirectly, onto the second side of the foil layer;
wherein the outermost adhesive layer, foil layer, and outermost release layer together form a cling foil.

14. The method of claim 13, wherein the outermost adhesive layer and outermost release layer are formed simultaneously.

15. The method of claim 13, wherein the outermost adhesive layer and outermost release layer are formed sequentially.
